(19) United States
(12) Patent Application Publication
(10) Pub. No.: US 2011/0050180 A1
(43) Pub. Date: Mar. 3, 2011

(54) Charging Control Circuit

(76) Inventor: Ti-Hua Ko, Taipei (TW)

(21) Appl. No.: 12/550,350

(22) Filed: Aug. 29, 2009

(51) Int. Cl. H02J 7/04

(52) U.S. Cl. 320/162

(57) ABSTRACT

A charging control circuit includes connecting terminals series-connected with one another and each adapted for connecting one battery, a current control circuit or both a current-restraining unit and a switch unit connected with each connecting terminal, a charging unit for charging the batteries, and a control unit for detecting the voltage of each connecting terminal to judge whether the connecting terminal disconnects with the battery or not and whether the battery is fully charged or not, then control the current control circuit or a switch state of the corresponding switch unit to adjust the flow direction of a charge current from the charging unit. When all of the batteries are detected to be fully charged, the control unit controls the current control circuits or switch units to be connected to divide the charge current, or controls the charging unit to directly provide a trickle current.

### BACKGROUND OF THE INVENTION

1. Field of the Invention

The present invention generally relates to a charging control circuit, and more particularly to a charging control circuit capable of effectively charging a plurality of series-connected rechargeable batteries.

2. The Related Art

A charging control circuit used to charge a rechargeable battery often has a control function for preventing the battery from being overcharged. That is to say, in the process of charging the battery, if the voltage of the battery is raised to a default value, then the charging control circuit will cut off a switch unit to terminate the charging process. Therefore the battery can avoid being damaged caused by overcharging.

However, when the above-mentioned charging control circuit is used to charge a plurality of series-connected rechargeable batteries, if the remained power in each battery differs from one another, then the battery having a more remained power therein will be charged to easily make the voltage thereof raised to the default value firstly. At this time, the charging control circuit will cut off the switch unit so as to protect the corresponding battery from being overcharged that prevents the charging control circuit from charging other batteries. Therefore, although the charging process is completed, some batteries are not fully charged to the default value that reduces the effectiveness of the batteries. Therefore, a charging control circuit capable of overcoming the foregoing problems is required.

### SUMMARY OF THE INVENTION

An object of the present invention is to provide a charging control circuit adapted for charging a plurality of rechargeable batteries. The charging control circuit includes a plurality of connecting terminals series-connected, a current-restraining unit, a switch unit, a charging unit and a control unit. Each of the connecting terminals includes a positive connecting point and a negative connecting point adapted for connecting one battery therebetween. The current-restraining unit and the switch unit are connected between the positive connecting point and the corresponding negative connecting point of each connecting terminal. The charging unit is adapted for charging the batteries connected with the connecting terminals. The control unit is adapted for detecting the voltage of each connecting terminal so as to judge whether the connecting terminal disconnects with the battery or not and whether the battery is fully charged or not according to the detected voltage signal, and then control a switch state of the corresponding switch unit to adjust the flow direction of a charge current from the charging unit according to the judged result, wherein when all of the batteries are detected to be fully charged, the control unit will control the corresponding switch units to be connected to divide the charge current through the corresponding current-restraining units for making only a trickle current flow through the fully charged batteries, or the control unit will directly control the charging unit to adjust the charge current into a trickle current for the fully charged batteries.

Another object of the present invention is to provide a charging control circuit adapted for charging a plurality of rechargeable batteries. The charging control circuit includes a plurality of connecting terminals series-connected with one another, a current control circuit, a charging unit and a control unit. Each of the connecting terminals includes a positive connecting point and a negative connecting point adapted for connecting one battery therebetween. The current control circuit is connected between the positive connecting point and the corresponding negative connecting point of each of the connecting terminals. The charging unit is adapted for charging the batteries connected with the connecting terminals. The control unit is adapted for detecting the voltage of each connecting terminal so as to judge whether the connecting terminal disconnects with the battery or not and whether the battery is fully charged or not according to the detected voltage signal, and then control the corresponding current control circuit to adjust the flow direction of a charge current from the charging unit according to the judged result, wherein when all of the batteries are detected to be fully charged, the control unit will control the corresponding current control circuits to divide the charge current for making only a trickle current flow through the fully charged batteries, or the control unit will directly control the charging unit to adjust the charge current into a trickle current for the fully charged batteries.

### BRIEF DESCRIPTION OF THE DRAWINGS

The present invention will be apparent to those skilled in the art by reading the following description, with reference to the attached drawings, in which:

FIG. 1 is a circuitry view of a charging control circuit according to a first embodiment of the present invention;

FIG. 2 is a concrete circuitry of the charging control circuit of FIG. 1;

FIG. 3 is a circuitry view of the charging control circuit of FIG. 2, wherein each of connecting terminals is connected with one rechargeable battery for executing a charge process;

FIG. 4 is a circuitry view of the charging control circuit of FIG. 2, wherein there is one of the connecting terminals unconnected with the rechargeable battery;

FIG. 5 is a circuitry view of the charging control circuit of FIG. 2, wherein there is one rechargeable battery connected with the corresponding connecting terminal fully charged;

FIG. 6 is a circuitry view of the charging control circuit of FIG. 2, wherein all of the rechargeable batteries connected with the connecting terminals are fully charged;

FIG. 7 is a circuitry view of the charging control circuit of FIG. 2, wherein all of the connecting terminals are unconnected with the rechargeable batteries; and

FIG. 8 is a circuitry view of a charging control circuit according to a second embodiment of the present invention.

### DETAILED DESCRIPTION OF THE PREFERRED EMBODIMENT

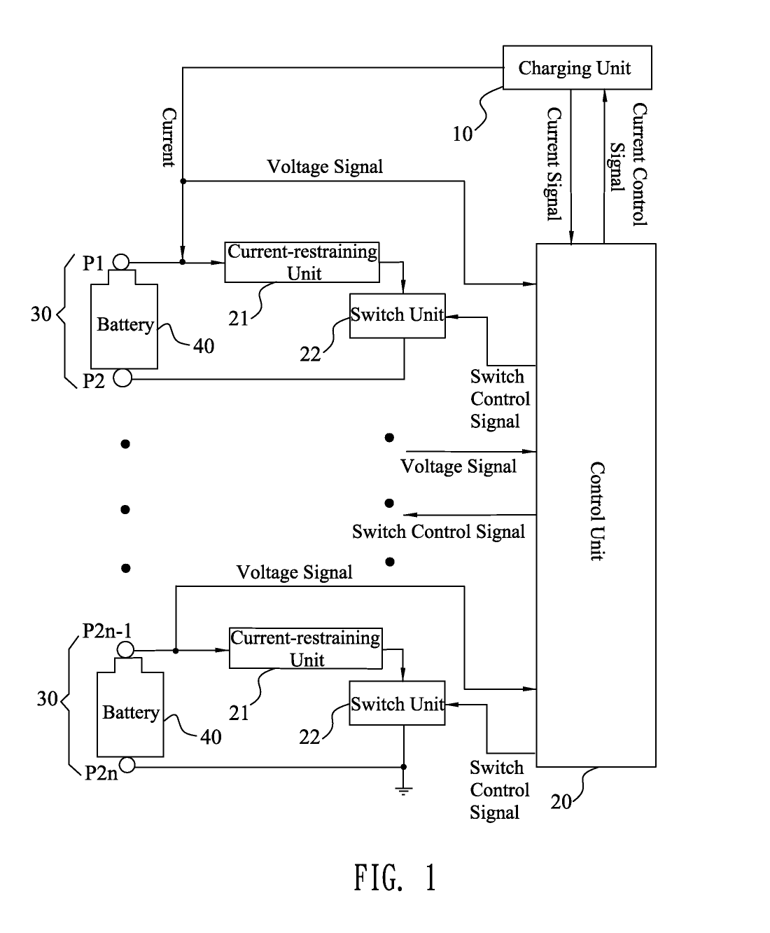

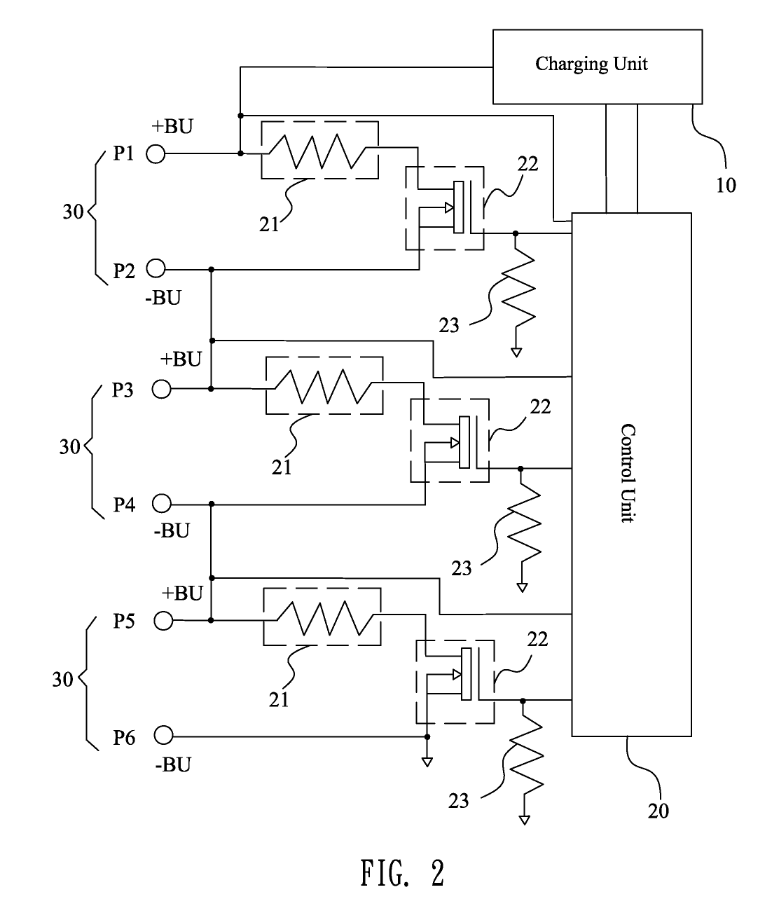

With reference to FIG. 1 and FIG. 2, a charging control circuit according to a first embodiment of the present invention is shown. The charging control circuit includes a charging unit 10, a plurality of connecting terminals 30 series-connected with one another, and a control unit 20. Each of the connecting terminals 30 includes a positive connecting point P1/P3/P5 . . . P2n-1 and a corresponding negative connecting point P2/P4/P6 . . . P2n. The charging unit 10 is connected between the outmost positive connecting point P1 and the control unit 20. The outmost negative connecting point P2n is connected to ground. A plurality of rechargeable batteries 40 can be respectively connected to the corresponding connecting terminals 30 for being charged by the charging control circuit.

The positive connecting point P1/P3/P5 . . . P2n-1 of each connecting terminal 30 is on one hand directly connected to the control unit 20 for transmitting a voltage signal to the control unit 20, and on the other hand, connected to the corresponding negative connecting point P2/P4/P6 . . . P2n through a current-restraining unit 21 and a switch unit 22 successively. The switch unit 22 is further connected with the control unit 20. The charging unit 10 can transmit a current signal to the control unit 20. The control unit 20 can judge whether the connecting terminal 30 disconnects with the rechargeable battery 40 or not and whether the rechargeable battery 40 is fully charged or not according to the voltage signal and the current signal, and then control a switch state of the corresponding switch unit 22 to adjust the flow direction of a charge current from the charging unit 10 according to the judged result so as to ensure each rechargeable battery 40 fully charged and further prevent the rechargeable battery 40 from being over-charged. If all of the rechargeable batteries 40 are detected to be fully charged, then the control unit 20 will control the corresponding switch units 22 to be connected to divide the charge current through the corresponding current-restraining units 21 for making only a trickle current flow through the fully charged batteries 40, or the control unit 20 will directly control the charging unit 10 to adjust the charge current into a trickle current for the fully charged batteries 40.

The current-restraining unit 21 can be a resistance element, a constant current circuit or a limited current circuit etc. The switch unit 22 can be a power MOS, a relay, an FET or an IGBT etc. In the first embodiment, the current-restraining unit 21 is a resistance element and the switch unit 22 is an N-channel FET having the drain connected with the current-restraining unit 21, the source connected with the corresponding negative connecting point P2/P4/P6 . . . P2n, and the grid connected with the control unit 20. The grid of the switch unit 22 is further connected to ground through a resistor 23.

Referring to FIGS. 2-7, the charge process of utilizing the charging control circuit to charge the rechargeable battery 40 will be described as follows, wherein the charging control circuit has three connecting terminals 30, namely three pairs of the positive and negative connecting points P1-P6.

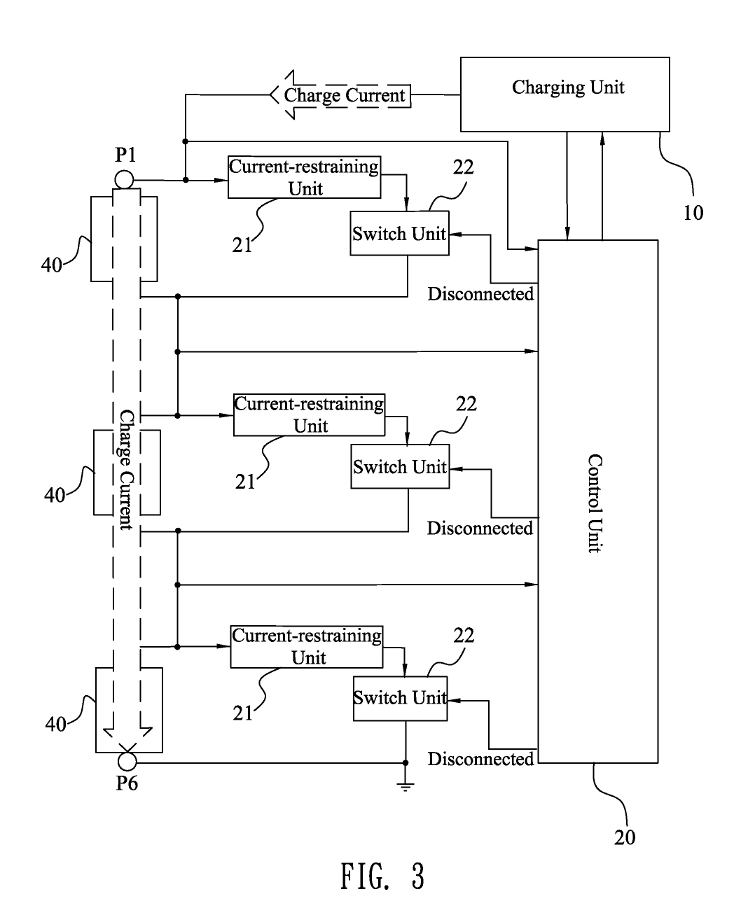

Referring to FIG. 2 and FIG. 3, when each of the three connecting terminals 30 is connected with one rechargeable battery 40, the control unit 20 will control the charging unit 10 to provide a charge current for the three rechargeable batteries 40. Simultaneously, the control unit 20 will control each of the switch units 22 to be disconnected to make the charge current successively flowed through the three rechargeable batteries 40 so as to charge the rechargeable batteries 40.

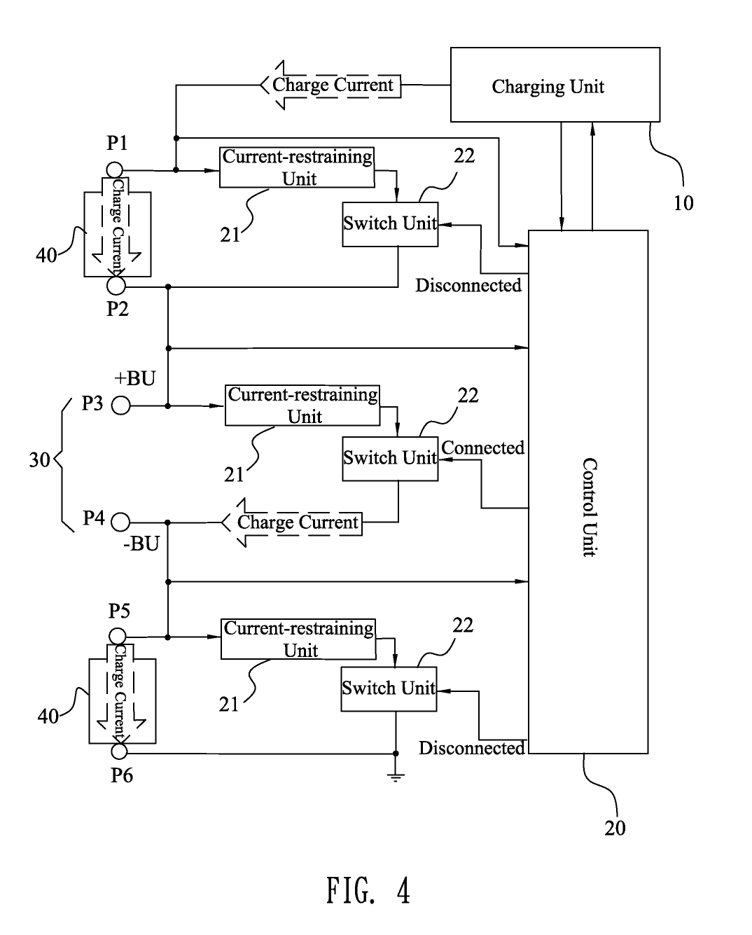

Referring to FIG. 2 and FIG. 4, if there is the connecting terminal 30 unconnected with the corresponding rechargeable battery 40, such as the positive connecting point P3 and the corresponding negative connecting point P4 without the rechargeable battery 40 connected therebetween, then the control unit 20 will control the corresponding switch unit 22, which is connected between the positive and the negative connecting points P3, P4, to be connected. At this time, the charge current from the charging unit 10 will successively flow through the rechargeable battery 40 connected between the positive connecting point P1 and the negative connecting point P2, the current-restraining unit 21 and the switch unit 22 connected between the positive connecting point P3 and the negative connecting point P4, and the rechargeable battery 40 connected between the positive connecting point P5 and the negative connecting point P6.

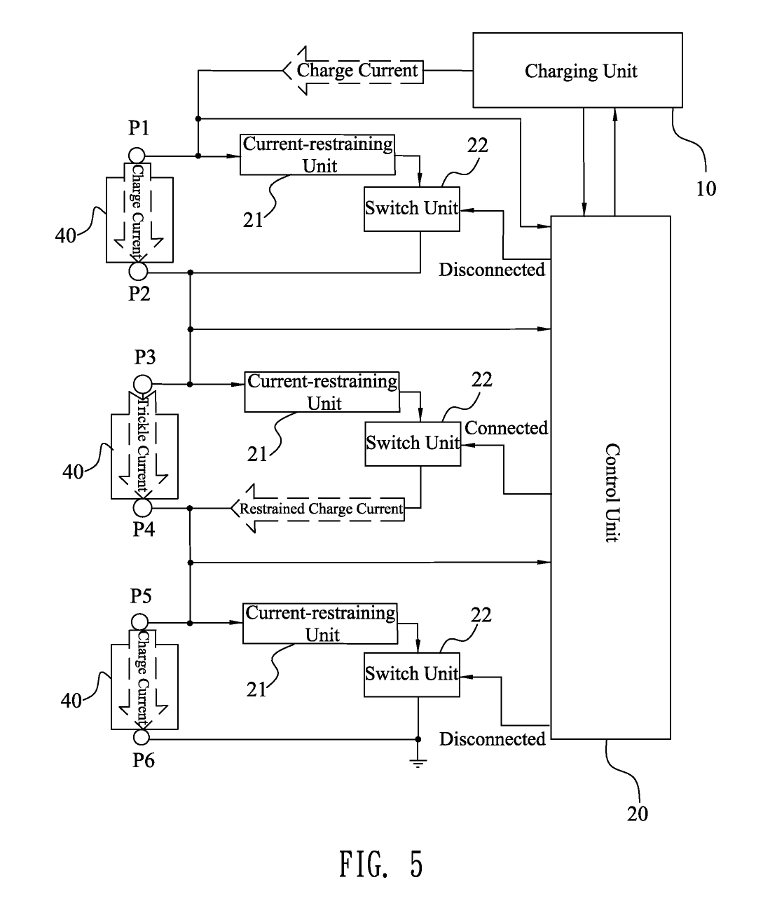

Referring to FIG. 2 and FIG. 5, if the rechargeable battery 40 is fully charged, for example, the rechargeable battery 40 connected between the positive connecting point P3 and the corresponding negative connecting point P4 is fully charged, then the control unit 20 will control the corresponding switch unit 22 to be connected to make the charging current, which flows through the rechargeable battery 40 connected between the positive connecting point P1 and the negative connecting point P2, divided into two branches. One of the two branches of currents which is restrained by the current-restraining unit 21 connected with the positive connecting point P3 successively flows through the current-restraining unit 21 and the corresponding switch unit 22, and the other branch of current is acted as a trickle current to flow through the fully charged rechargeable battery 40 so as to protect the rechargeable battery 40 from being over-charged. Then the restrained current and the trickle current are converged to flow through the rechargeable battery 40 connected between the positive connecting point P5 and the negative connecting point P6. So the rechargeable batteries 40 not yet been fully charged will keep on being charged even if some of the rechargeable batteries 40 are fully charged.

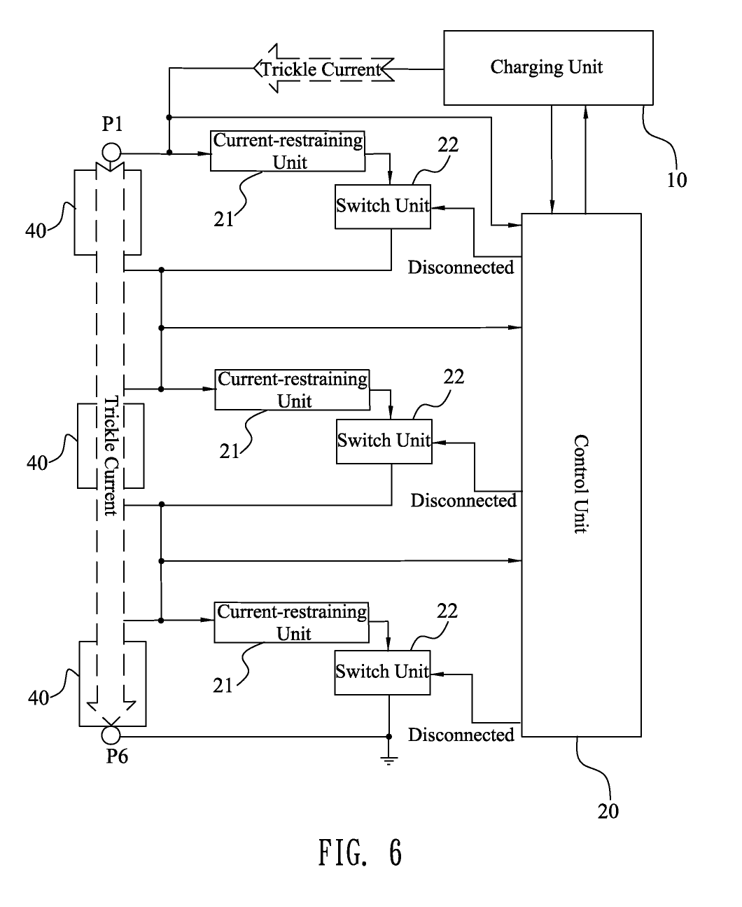

Referring to FIG. 2 and FIG. 6, if each of the rechargeable batteries 40 connected with the three connecting terminals 30 is fully charged, then the control unit 20 will control all of the switch units 22 to be connected to divide the charge current for making only the trickle current flow through the rechargeable batteries 40, or the control unit 20 will control the charging unit 10 to directly provide a trickle current for the rechargeable batteries 40. So the fully charged rechargeable batteries 40 can avoid being over-charged. In the first embodiment, if each of the rechargeable batteries 40 is fully charged, then the control unit 20 will control the charging unit 10 to directly provide the trickle current for the rechargeable batteries 40.

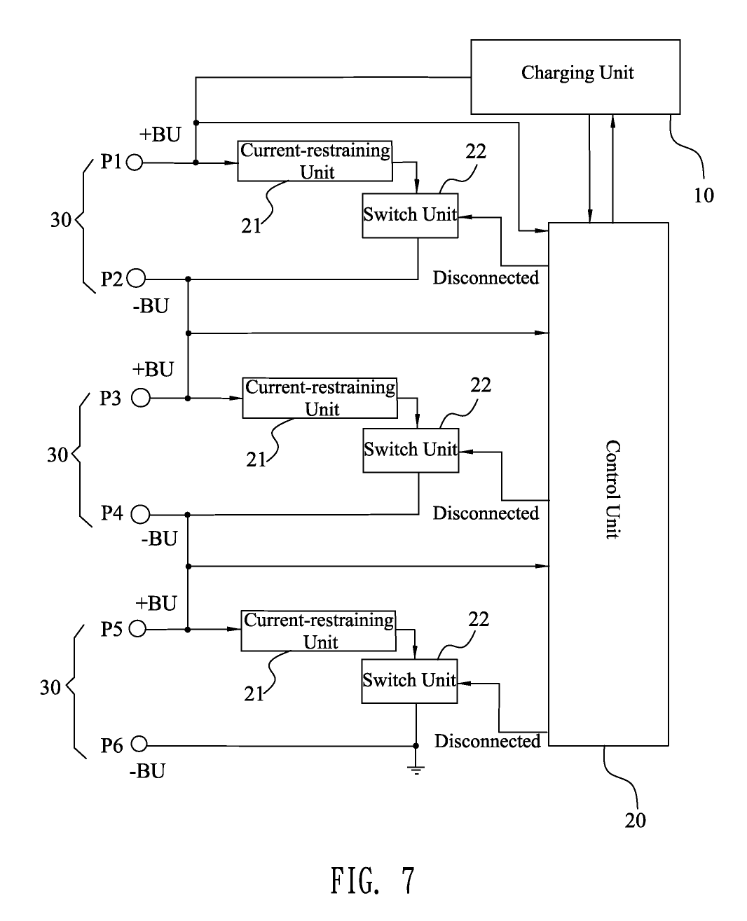

Referring to FIG. 2 and FIG. 7, if all of the rechargeable batteries 40 are withdrawn out of the corresponding connecting terminals 30, then the control unit 20 will control all of the switch units 22 to be disconnected, or the control unit 20 will control the charging unit 10 to stop working. In the first embodiment, if all of the rechargeable batteries 40 are withdrawn out of the corresponding connecting terminals 30, then the control unit 20 will control all of the switch units 22 to be disconnected.

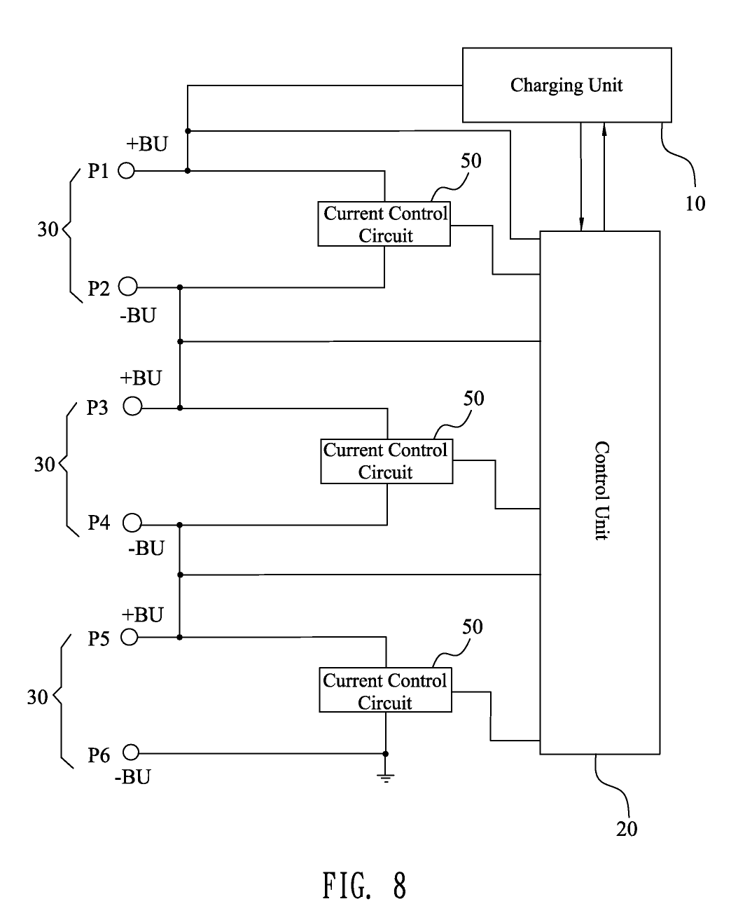

Referring to FIG. 8, a charging control circuit according to a second embodiment of the present invention is shown and has a similar circuit to the first embodiment. The difference is that both the current-restraining unit 21 and the corresponding switch unit 22 connected with each of the connecting terminals 30 in the first embodiment are replaced by a current control circuit 50 in the second embodiment. The current control circuit 50 can be a constant current circuit or a limited current circuit. The charge process of utilizing the charging control circuit of the second embodiment to charge the rechargeable battery 40 is same to the charge process in the first embodiment, so it will not be described any more.

As described above, the charging control circuit of the present invention utilizes the control unit 20 to accurately control the charging unit 10 and the switch units 22 or the current control units 50 according to the voltage signal and the current signal so as to further control the charging current through each rechargeable battery 40. So each rechargeable battery 40 connected in the charging control circuit can be charged completely and efficiently, and further can avoid being over-charged.

What is claimed is:

1. A charging control circuit adapted for charging a plurality of rechargeable batteries, comprising:
a plurality of connecting terminals series-connected with one another, each of the connecting terminals including a positive connecting point and a negative connecting point adapted for connecting one battery therebetween;
a current-restraining unit and a switch unit connected between the positive connecting point and the corresponding negative connecting point of each connecting terminal;
a charging unit for charging the batteries connected with the connecting terminals; and
a control unit for detecting the voltage of each connecting terminal so as to judge whether the connecting terminal disconnects with the battery or not and whether the battery is fully charged or not according to the detected voltage signal, and then control a switch state of the corresponding switch unit to adjust the flow direction of a charge current from the charging unit according to the judged result, wherein when all of the batteries are detected to be fully charged, the control unit will control the corresponding switch units to be connected to divide the charge current through the corresponding current-restraining units for making only a trickle current flow through the fully charged batteries, or the control unit will directly control the charging unit to adjust the charge current into a trickle current for the fully charged batteries.

2. The charging control circuit as claimed in claim 1, wherein the current-restraining unit is a resistance element, a constant current circuit or a limited current circuit.

3. The charging control circuit as claimed in claim 1, wherein the switch unit is a power MOS, a relay, an FET or an IGBT.

4. A charging control circuit adapted for charging a plurality of rechargeable batteries, comprising:
a plurality of connecting terminals series-connected with one another, each of the connecting terminals including a positive connecting point and a negative connecting point adapted for connecting one battery therebetween;
a current control circuit connected between the positive connecting point and the corresponding negative connecting point of each of the connecting terminals;
a charging unit for charging the batteries connected with the connecting terminals; and
a control unit for detecting the voltage of each connecting terminal so as to judge whether the connecting terminal disconnects with the battery or not and whether the battery is fully charged or not according to the detected voltage signal, and then control the corresponding current control circuit to adjust the flow direction of a charge current from the charging unit according to the judged result, wherein when all of the batteries are detected to be fully charged, the control unit will control the corresponding current control circuits to divide the charge current for making only a trickle current flow through the fully charged batteries, or the control unit will directly control the charging unit to adjust the charge current into a trickle current for the fully charged batteries.

5. The charging control circuit as claimed in claim 4, wherein the current control circuit is a constant current circuit or a limited current circuit.
